(19) United States
(12) Patent Application Publication
(10) Pub. No.: US 2015/0052071 A1
(43) Pub. Date: Feb. 19, 2015

(54) Method of Integrating Events and System Thereof

(71) Applicant: Acer Inc., New Taipei City (TW)

(72) Inventors: Meng-Ta Tsai, New Taipei City (TW); Nan-Kuang Chen, New Taipei City (TW); Jen-Hao Cheng, New Taipei City (TW)

(73) Assignee: Acer Inc., New Taipei City (TW)

(21) Appl. No.: 14/269,261

(22) Filed: May 5, 2014

(30) Foreign Application Priority Data
Aug. 19, 2013 (TW) 102129726

(51) Int. Cl. G06Q 50/00; G06Q 10/00

(52) U.S. Cl. CPC G06Q 50/01; G06Q 10/00
USPC 705/319

(57) ABSTRACT

An event integrating and displaying method for an electronic apparatus is disclosed. The method includes the follow steps: collecting a plurality of events established by different sources; calculating an event similarity between any two target events of the plurality of events to determine whether the event similarity exceeds a defined value, wherein the event similarity is obtained from calculating a time similarity, a location similarity, and an attendance similarity between the two target events; if the event similarity exceeds the defined value, integrating the two target events into an identical event.

### FIELD OF THE INVENTION

The exemplary embodiments of the present invention relate to a method of integrating events. More specifically, the exemplary embodiments of the present invention relate to a method of integrating events that determines the similarity of different events to decide whether to integrate these events into an identical event.

### BACKGROUND OF THE RELATED ART

Because mobile apparatuses and wireless Internet access are increasing in popularity, users can utilize mobile apparatuses at any time to announce personal dynamic events or related dynamic events to other people through different social network services, sort these dynamic events along a timeline, and further display the content of these dynamic events. Examples of common social network services are FACEBOOK, TWITTER or WEIBO.

Usually, each dynamic event announced through social network services is an independent event. On FACEBOOK, for example, if the user announces a content of attending a party with friends or checks into a place at time a, and later the user uploads a photo of such party at time b, even though the contents of these two events are related to the same party announced by the user, FACEBOOK will treat these two events as independent events. Therefore, the increase in dynamic events having similar content will not only waste the display interface resources of FACEBOOK but also cause inconvenience when the user searches for or views the related dynamic events. In addition, if the user is in the habit of utilizing several social network services to announce the event content, then when searching for information related to a certain event, the user has to execute different social network services to view the information or execute a search, and that will increase the time and complication of searching for the certain event.

In addition, when the user wants to search for the interaction state of a certain character, the user can only review the dynamic events related to that character one by one, and the social network services such as FACEBOOK do not provide related searching functions, so it is not convenient to the user.

Therefore, it is worthwhile to develop a method to determine the similarity of different events and further integrate two target events with high similarity into an identical event.

### SUMMARY OF THE INVENTION

The main object of the present invention is to provide a method of integrating events that determines the similarity of different events to decide whether to integrate these events into an identical event.

In order to achieve the aforementioned object, the method of integrating events of the present invention is adapted to an electronic apparatus, and the method comprises the following steps: collecting a plurality of established events; sorting the plurality of events according to a time of occurrence recorded in the plurality of events; calculating an event similarity between any two target events of the plurality of events and determining whether the event similarity exceeds a defined value, wherein the event similarity is obtained from calculating an event time similarity, an event attendant similarity, and an event location similarity between the two target events; and if the event similarity exceeds the defined value, integrating the two target events into an identical event.

The present invention further comprises an event integrating system using the aforementioned method.

By this design, the method of integrating events and display method of the present invention can collect events established by different sources, decide whether to integrate any two events into an identical event according to the event similarity calculated from the two events, and sort and display each event processed according to the time.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a system block diagram of the event integrating system in accordance with the present invention.

FIG. 2 is a flowchart of the method of integrating events in accordance with the present invention.

FIG. 3 is a schematic diagram of the operation interface of the event integrating system in accordance with the present invention.

FIG. 4 a flowchart of another embodiment of the event integrating and display method of the method of integrating events.

### DETAILED DESCRIPTION

For facilitating understanding and clarifying the object, characteristics, and advantages of the present invention, the following specific embodiments and figures of the present invention are presented to provide a detailed description.

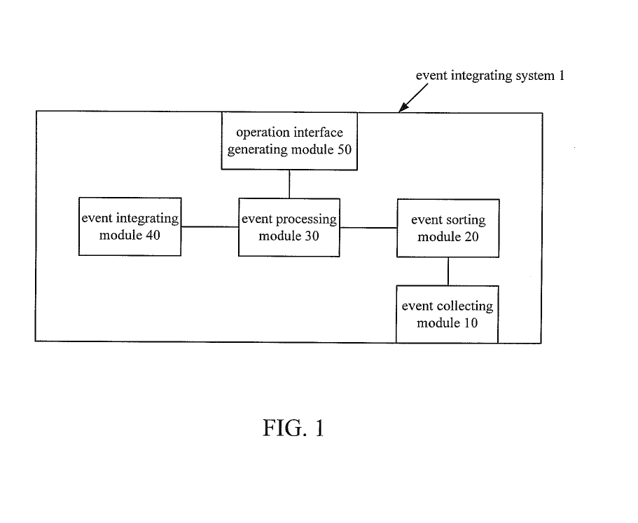

Please first refer to FIG. 1, which is a system block diagram of the event integrating system in accordance with the present invention. The event integrating system 1 of the present invention can be adapted to a portable electronic apparatus; the portable electronic apparatus can be a smart phone, a portable computer, or other similar portable electronic apparatus. The event integrating and display system can be at least one of the hardware, software, or firmware installed in the portable electronic apparatus, or a system composed of at least two of the abovementioned components, but the present invention is not limited thereto.

At least one event establishing application program is installed in the portable electronic apparatus, or the portable electronic apparatus can provide an on-line login function of the social network service to establish different events. Here, the event establishing application program can be a calendar program, and the social network service can be FACEBOOK, TWITTER or WEIBO. The events established by the event establishing application program or the social network services can include a word recording event (such as newly acquired information, an event record, or a memorandum), a multimedia information announcement event (such as dynamic or static image uploading), or an information recording event (such as checking into a place).

In addition, the portable electronic apparatus also comprises a time unit and a positioning unit. The time unit is configured for recording the time information and for adding the time information into the event when the event is established; here, the time unit can be a timer. The positioning unit is configured for recording the position information and for adding the position information (the geographic position when the user establishes the event) into the event when the event is established; here, the positioning unit can be a global positioning system (GPS), and the GPS is configured for detecting and obtaining the position of the apparatus.

As shown in FIG. 1, in one embodiment of the present invention, the event integrating system 1 of the present invention comprises an event collecting module 10, an event sorting module 20, an event processing module 30, and an event integrating module 40, wherein the event processing module 30 is electrically connected with other modules.

The event collecting module 10 is configured for collecting a plurality of established events. The event collecting module 10 will search the events established by the event establishing application program in the apparatus, and/or logging in online to every social network service to collect all established events. In other words, the event collecting module 10 can collect events from different sources, but it is not limited to executing the event collection only toward those events established by a single source.

The event sorting module 20 is configured for sorting the plurality of events according to a time of occurrence recorded in the plurality of events. After the event collecting module 10 collects the plurality of events, the event sorting module 20 will sort the plurality of events on a timeline according to the time of occurrence of each event, so as to check the occurring sequence of those events.

Every event has a corresponding time of occurrence; for example, a social network service such as FACEBOOK is often used to record a dynamic event that is occurring or has occurred; thus, for an instantaneous event established by FACEBOOK, the present invention will take the time that the instantaneous event is established as the time of occurrence. The calendar is usually used for recording the events that will occur; thus, for the future event (for example, calling a meeting) established by the calendar program, the present invention will take the time that the event starts to be executed (i.e., the start time of the meeting) as the time of occurrence, but not the time that the event is established. In other words, the time of occurrence of the events here will be different according to the event type or the sources establishing the events.

The event processing module 30 is configured for determining whether the event similarity between any two target events of the plurality of events exceeds a defined value. The event processing module 30 will select any two events from the events after sorting as two target events, and determine the event similarity of the two events. For example, the event processing module 30 can select two events of which the times of occurrence or the locations are close in proximity as the two target events, but the present invention is not limited thereto; in addition, the two target events will form different event type combinations because each of the target events belongs to a different event type. For instance, each event can be of different types, such as a word recording event (such as newly acquired information or a message), a multimedia information announcement event (such as video or photo sharing), or an information recording event (such as checking into a place). The event processing module 30 can set a corresponding defined value according to the event type combinations of the two target events.

The aforementioned event similarity is obtained by weighted average calculation of an event time similarity, an event attendant similarity, and an event location similarity between the two target events; the event time similarity, the event attendant similarity, and the event location similarity are obtained by using a corresponding similarity calculating formula. After calculating the event similarity of the two target events, the event processing module 30 can find the corresponding defined value according to the event type combination of the two target events and determine whether the event similarity exceeds the corresponding defined value.

If the event processing module 30 determines that the event similarity of the two target events exceeds the defined value, then the event integrating module 40 will integrate the two target events into an identical event.

In addition, the event integrating system 1 can further comprise an interface generating module 50 configured for generating an operation interface to display the plurality of events including the integrated events, or the events can not be integrated, and the user can browse and operate via the operation interface.

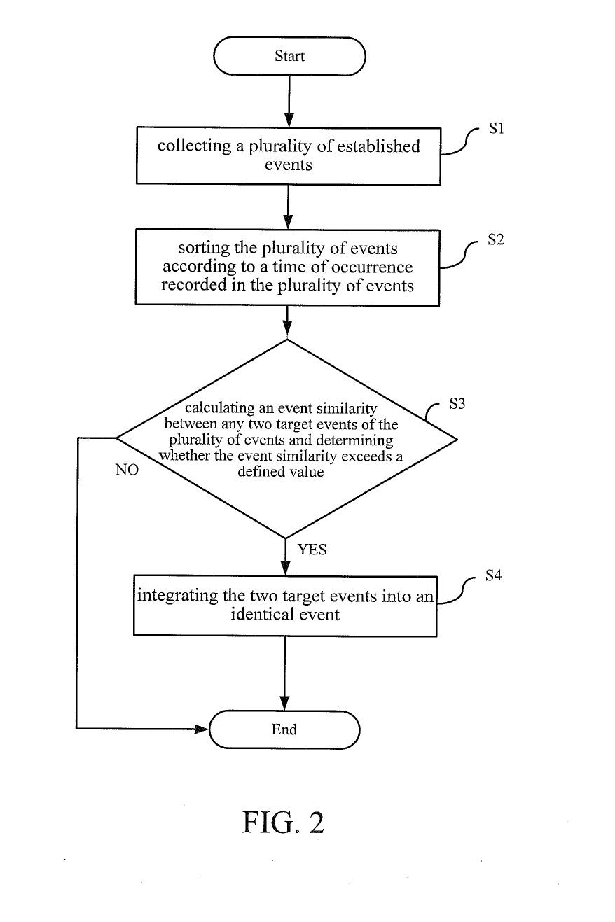

Please refer to FIG. 2, which is a flowchart of the method of integrating events in accordance with the present invention. It has to be noted that though the event integrating system 1 shown in FIG. 1 is used as an example to describe the method of integrating events of the present invention, the present invention is not limited thereto, and the method can be adapted to any system or electronic apparatus having a similar structure and function. As shown in FIG. 2, the method of integrating events of the present invention comprises step S1 to step S4. Each corresponding step will be explained in detail according to the embodiments.

Step S1: collecting a plurality of established events.

When the event integrating system 1 of the present invention receives the user command, the event collecting module 10 will actively search the plurality of events established by the same source (for example by FACEBOOK) or by different sources (for example by FACEBOOK and TWITTER).

Step S2: sorting the plurality of events according to a time of occurrence recorded in the plurality of events.

After collecting the plurality of events, the event sorting module 20 can first sort the events according to the time of occurrence corresponding to each event, so as to confirm the sequence of occurrence of the events, and at the same time to determine which events having times of occurrence in close proximity to each other.

Step S3: calculating an event similarity between any two target events of the plurality of events and determining whether the event similarity exceeds a defined value; wherein the event similarity is obtained from calculating an event time similarity, an event attendant similarity, and an event location similarity between the two target events.

After the above step of sorting events, the event processing module 30 can select any two events from all the events as two target events. In the method of the present invention, the event time information, the attendant information, and the location information need to be compared, wherein the event processing module 30 can obtain candidates of the target events by filtering the plurality of events to obtain the events, including the attendant information and the location information. Moreover, the event processing module 30 can also select two events having close times of occurrence or locations as the two target events, so as to increase the processing speed.

Next, please refer to Table 1, which is an embodiment of the selected two target events.

| | Event 1 | Event 2 |
|---|---|---|
| Event type | Word recording event | Multimedia |
| | | information |
| | | announcement event |
| Time of occurrence | May 14, 2013 14:00:00 | May 14, 2013 14:15:00 |
| Location (longitude | 121.564099, 25.033408 | 121.566693, 25.038791 |
| and latitude | | |
| coordinates) | | |
| Attendants | A, B, C, D | A, B, D, E, F, G |

Next the calculation of the event time similarity and the event location similarity is used as an example to describe the method of integrating events. In one embodiment of the present invention, the calculation formulas of the event time similarity and the event location similarity are shown as follows, but the present invention is not limited thereto:

CI_{T}=cos(π/2*(T/Tₘₐₓ)) (1)

CI_{D}=cos(π/2*(D/Dₘₐₓ)) (2)

In formula (1), CI_{T} is the event time similarity; T is the event time difference between the two target events; Tₘₐₓ is the set time value. In the formula (2), CI_{D} is the event location similarity; D is the event location difference between the two target events; Dₘₐₓ is the set distance value. Through formula (1) and formula (2), the event time similarity CI_{T} and the event location similarity CI_{D} are between 0 and 1 respectively.

As shown in Table 1, the event time difference T between the event 1 and the event 2 is 15 minutes. It is assumed that the set time Tₘₐₓ set by the event processing module 30 is 60 minutes, and the event processing module 30 can first determine that the time difference T is within the range of the set time Tₘₐₓ; thus, the event processing module 30 will start to calculate the event time similarity CI_{T}; here, through formula (1), the event time similarity CI_{T} is 0.92. In contrast, if the event time difference T between the event 1 and the event 2 exceeds the set time Tₘₐₓ, then the event time similarity CI_{T} of the event 1 and the event 2 can be set to zero directly.

Similarly, as shown in Table 1, according to the coordinates of the event 1 and the event 2, the event location difference D is 250 m.

It is assumed that the set distance Dₘₐₓ set by the event processing module 30 is 500 m, and the event processing module 30 can first determine that the event location difference D is within the range of the set distance Dₘₐₓ; thus, the event processing module 30 will start to calculate the event location similarity CI_{D}; here, through formula (1), the event location similarity CI_{D} is 0.71. In contrast, if the event location difference D between the event 1 and the event 2 exceeds the set distance Dₘₐₓ, then the event location similarity CI_{D} of the event 1 and the event 2 can be set to zero directly.

For the event character similarity, in one embodiment of the present invention, the event character similarity can be obtained by the similarity formula proposed by Jaccard. The formula is shown as follows:

CI_{A}=A1/(A1+A2+A3) (3)

In formula (3), CI_{A} is the event character similarity; A1 is the total number of the attendants of the event 1 and the event 2; A2 is the number of attendants only at the event 1; A3 is the number of attendants only at the event 2. By formula (3), the event character similarity CI_{A} is between 0 and 1. It has to be noted here that a formula to obtain the event character similarity CI_{A} can also be another formula, such as DICE or 3W-Jaccard, but the present invention is not limited thereto.

As shown in Table 1, the attendants of the event 1 and the event 2 are A, B and D; C attends only the event 1, and E, F and G attend only the event 2; here, by the formula (3), the event character similarity CI_{A} is 0.43.

By the above formulas (1)˜(3), the event processing module 30 can obtain the event time similarity CI_{T}, the event location similarity CI_{D}, and the event character similarity CI_{A}; therefore, the event processing module 30 can further obtain the event similarity of the event 1 and the event 2. For example, the event processing module 30 can obtain an average value of the event time similarity CI_{T}, the event location similarity CI_{D}, and the event character similarity CI_{A}, and the average value is taken as the event similarity of the event 1 and the event 2; e.g., the event similarity is 0.69. In addition, the event processing module 30 can use the weighted averages method to obtain the event similarity according to the event time similarity CI_{T}, the event location similarity CI_{D}, and the event character similarity CI_{A}. For instance, in the present invention, the accuracy degree of determining the event location similarity CI_{D} is higher; thus, the weight of the event location similarity CI_{D} is set as 3, and the other two are set as 1, and thus the event similarity will be 0.7.

It is assumed here that the defined value set by the event processing module 30 for the event type combination of the word content announcement event and the multimedia information announcement event is 0.6. Thus, when executing step S3, the event processing module 30 will compare the similarity of the event 1 and the event 2 with the defined value, so as to determine whether the event similarity exceeds the defined value. In the present example, in which the defined value is 0.6, the event similarities obtained by all the above steps exceed the defined value; if the defined value is set to 0.7, then only the event similarity obtained by the weight average calculation will exceed the defined value. If the event processing module 30 determines that the event similarity of the event 1 and the event 2 exceeds the defined value, then step S4 will be performed; if the event processing module 30 determines that the event similarity of the event 1 and the event 2 is not over the defined value, then the event 1 and the event 2 will not be integrated; i.e., the event 1 and the event 2 will remain independent events respectively.

Step S4: integrating the two target events into an identical event.

After the above step S3, the event similarity of the event 1 and the event 2 is determined to exceed the defined value; it is indicated that the event 1 and the event 2 are events related to the same subject, and thus the event integrating module 40 will integrate the event 1 and the event 2 into an identical event.

After finishing the integration of the two target events, or determining that the two target events do not exceed the defined value, the event processing module 30 can continue selecting another two events as two new target events and re-execute the step S3, and the steps will be executed repeatedly till the events which can be integrated have all been processed.

The integrated events and the events that cannot be integrated can be displayed by the operation interface generated by the operation interface generating module 50, and the events can be sorted by the event sorting module 20 according to the corresponding time of occurrence of each event.

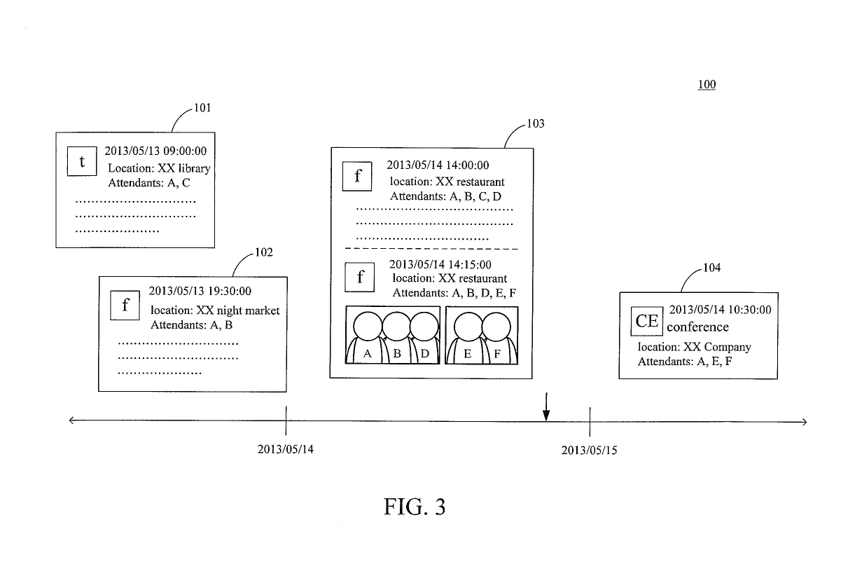

Please refer to FIG. 3, which is a schematic diagram of the operation interface of the event integrating system in accordance with the present invention. As shown in FIG. 3, in the operation interface 100, the integrated events 103 and the events that can not be integrated 101, 102, and 104 are displayed in order, wherein the event 103 is generated by integrating the event 1 and the event 2 in the above table, and the events 101, 102 and 104 are single events respectively. Each event will display related information such as the corresponding time of occurrence, the event location, the attendants, and the detailed content of the events. In FIG. 3, the event 101 is established by TWITTER, the events 102 and 103 are established by FACEBOOK, and the event 104 is established by the calendar program.

In the operation interface 100, the time of occurrence of the corresponding event will be displayed on a timeline; an arrow is used to indicate the current time in the operation interface. In the operation interface 100, the timeline not only includes the time before the current time so as to show a record of the history of the event that occurred (such as the established events 101, 102 and 103), but also the time after the current time so as to show the remainder event which does not occur but is recorded (such as the remainder event 104 established by the calendar software).

By the design of the present invention, the plurality of events from different sources can be collected and two events having high similarity can be integrated, and thus not only can the number of the events be decreased to save the interface source, but also the user can more easily view or search for the events.

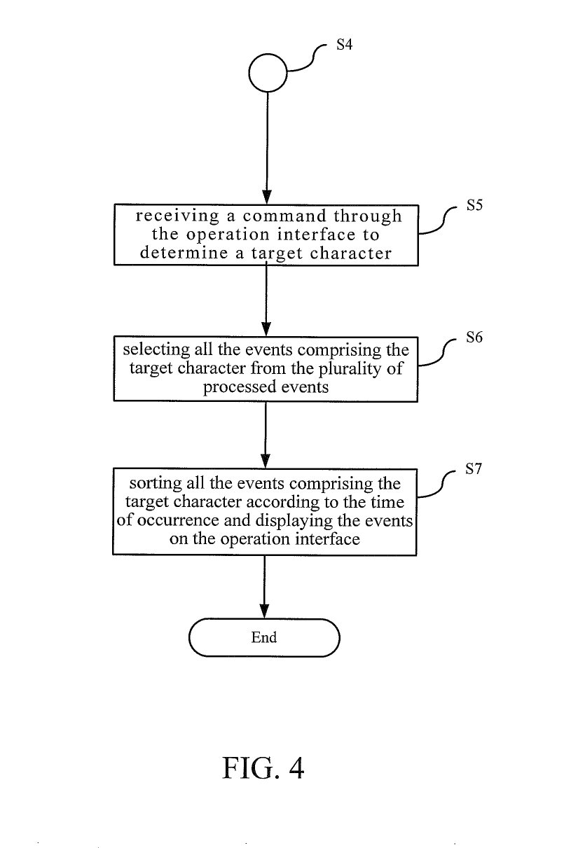

Please refer to FIG. 4, which is a flowchart of another embodiment of the method of integrating and displaying events. As shown in FIG. 4, in another embodiment of the present invention, the method of integrating events further comprises step S5 and step S7. The steps of the method will be further described below.

After step S4, the method further comprises step S5: receiving a command through the operation interface to determine a target character.

The event integrating and displaying system 1 can collect all the attendants included in the events processed and present that collected information on the operation interface of the event integrating and displaying system 1 in accordance with the present invention. The user can select one target character by inputting a corresponding command through the operation interface, and the event integrating and displaying system 1 will determine which target character is selected according to the command.

Step S6: selecting all the events comprising the target character from the plurality of processed events.

When the event integrating and displaying system 1 determines the target character, the event processing module 30 will filter all of the plurality of events processed so as to obtain all the events comprising the target character.

Step S7: sorting all the events comprising the target character according to the time of occurrence and displaying the events on the operation interface.

When the event processing module 30 obtains all the events comprising the target character, the event sorting module 20 can then sort all the events comprising the target character according to the corresponding time of occurrence and display the result through the interface displaying module 50. Thus, the user can understand all the events comprising the target character and further confirm the interactions with the target character.

By the present design, the method of integrating and displaying events of the present invention can collect events from different sources and calculate the event similarity between any two target events according to the corresponding event time of occurrence, the event location, and the attendants, so as to determine whether these two events can be integrated into a single event; in addition, the events are sorted according to time to help the user to rearrange and display all the established events. At the same time, the user can select one character to present all the interaction events related to that character, providing greater convenience to the user.

In summary, regardless of the function, the way and result of the present invention are shown to have technical characteristics different from those of the prior arts. However, the aforementioned embodiments are only for illustrating the principle and the result of the present invention, and should not be construed to limit the range of the present invention. It will be obvious to those skilled in the art that, based upon the descriptions herein, changes and modifications may be made without departing from the invention and its broader aspects. Therefore, the appended claims are intended to encompass within their scope all such changes and modifications as are within the true spirit and scope of the exemplary embodiments of the present invention.

What is claimed is:

1. An method of integrating events, adapted to an electronic apparatus, the method comprising the following steps:
collecting a plurality of established events;
sorting the plurality of events according to a time of occurrence recorded in the plurality of events;
calculating an event similarity between any two target events of the plurality of events and determining whether the event similarity exceeds a defined value, wherein the event similarity is obtained from calculating an event time similarity, an event attendant similarity, and an event location similarity between the two target events; and
if the event similarity exceeds the defined value, integrating the two target events into an identical event.

2. The method of integrating events as claimed in claim 1, wherein when an event time difference of the two target events is smaller than a set time value, the method performs calculations to obtain the event time similarity according to the event time difference.

3. The method of integrating events as claimed in claim 1, wherein when an event location difference of the two target events is smaller than a set distance value, the method performs calculations to obtain the event location similarity according to the event location difference.

4. The method of integrating events as claimed in claim 1, further comprising calculation to obtain the event character similarity according to attendant information of at least one of the two target events.

5. The method of integrating events as claimed in claim 1, wherein the plurality of events is established by different sources.

6. The method of integrating events as claimed in claim 1, wherein the defined value is adjusted according to an event type combination of the two target events.

7. The method of integrating events as claimed in claim 1, wherein the target event is obtained by filtering the plurality of events to obtain the event including attendant information and location information.

8. The method of integrating events as claimed in claim 1, further comprising the following steps:
determining a target character by receiving a command through an operation interface;
obtaining all the events including the target character from the plurality of events processed; and
sorting all the events including the target character according to the time of occurrence, and displaying all the events including the target character on the operation interface.

9. An event integrating system, comprising:
an event collecting module, configured for collecting a plurality of established events;
an event sorting module, configured for sorting the plurality of events according to a time of occurrence recorded in the plurality of events;
an event processing module, configured for calculating an event similarity between any two target events of the plurality of events and determining whether the event similarity exceeds a defined value; wherein the event similarity is obtained from calculating an event time similarity, an event attendant similarity, and an event location similarity between the two target events; and
an event integrating module, configured for integrating the two target events into an identical event when the event similarity of the two target events exceeds the defined value.

10. The event integrating system as claimed in claim 9, wherein when the event processing module determines that an event time difference of the two target events is smaller than a set time value, the event processing module calculates the event time similarity according to the event time difference.

11. The event integrating system as claimed in claim 9, wherein when the event processing module determines that an event location difference of the two target events is smaller than a set distance value, the event processing module calculates the event location similarity according to the event location difference.

12. The event integrating system as claimed in claim 9, wherein the event processing module calculates the event character similarity according to an attendant information of at least one of the two target events.

13. The event integrating system as claimed in claim 9, wherein the plurality of events are established by different sources.

14. The event integrating system as claimed in claim 9, wherein the defined value is adjusted according to an event type combination of the two target events.

15. The event integrating system as claimed in claim 9, wherein the event processing module obtains the target event by filtering the plurality of events to get the event including an attendant information and a location information.

16. The event integrating system as claimed in claim 9, further comprising an interface generating module configured for generating an operation interface;
wherein a target character is determined by receiving a command through an operation interface, the event processing module obtains all the events including the target character from the plurality of events processed, and the event processing module orders the event sorting module to sort all the events including the target character according to a time of occurrence and displays all the events including the target character on the operation interface.
